(19) United States
(12) Patent Application Publication
(10) Pub. No.: US 2005/0012055 A1
(43) Pub. Date: Jan. 20, 2005

(54) Optical method for detecting object

(76) Inventor: Su-Ching Chien, I-Lan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/694,784

(22) Filed: Oct. 29, 2003

(30) Foreign Application Priority Data
Jul. 18, 2003 (TW) 92119644

(51) Int. Cl. G01V 8/00

(52) U.S. Cl. 250/559.01

(57) ABSTRACT

The present invention provides a method for detecting the object by using the refraction and reflection, in conjunction with the coded signal. The detecting method includes the signal is generated in binary code, and the modulated coded signals are emitted from the light sources that have different position and the emitting angle within the light emitting source flat array. Thus, the photosensitive device can determine the object is existence and measure the object size and distance that according to the reflected modulation light beam and a corresponding code information therewithin. Furthermore, the three-dimensional moving direction and the moving rate of the object are calculated by the reflected modulation light beam and the coded signals therewithin.

### BACKGROUND OF THE INVENTION

1. Field of the Invention

The present invention generally relates to an optical method for detecting the status of an object, and more particularly to an optical method to utilize the reflection and refraction in conjunction with the coded signals to detect the object.

2. Description of the Prior Art

In general, the object can be detected by using the infrared sensor, ultrasonic sensor, or laser-detecting device. The infrared sensor can detect existence of the object, and can response to the hot object, such as an infrared thermometer, which merely measures the body temperature of the human being but cannot distinguish whether the object is a human being or a cold-blooded animal. The thermal radiation can be detected by thermo scanner imaging system, wherein the infrared sensor is an important element within the thermo scanner imaging system that can convert the infrared radiation into the physics quantity, and output the result with the electrical type. Nevertheless, the thermo scanner imaging system cannot obtain the motion status of object, the size, or moving direction of the object.

Moreover, the conventional detecting method such as ultrasonic sensor only detected the object in the finite region, such that the ultrasonic sensor cannot obtain the moving status, or moving rate, and the resolution is poor for the conventional detecting device. Therefore, the practicability has its restrictions. In addition, the radar-detecting device and radar ranging device only detected the speed and distance of the object, but the moving direction, the size, or the height of the object cannot be measured by the detecting device.

### SUMMARY OF THE INVENTION

It is an object of the invention to utilize the reflection and refraction in conjunction with the coded signals to detect the object by the modulation light beam and containing coded signals are emitted from the light sources.

It is a further object of this invention is to utilize the reflection and the refraction in conjunction with the coded signals within to detect the position of an object by emitting the modulation light beam in different position and different emitting angle within a light emitting source flat array.

It is yet another object of this invention is to utilize the reflection and the refraction in conjunction with the coded signals to obtain the moving direction and the moving rate of an object by the photosensitive device to receive the reflected modulation light beam and the corresponding code information therewithin from the object in the different reflected time.

According to the above objects, the present invention provides an optical method for detecting an object by utilizing the refraction and reflection in conjunction with the coded signals. The optical detecting method includes the modulation light beam is emitted from light sources within a light emitting source flat array to detect the existence of the object in the detecting range. When the photosensitive device received the reflected modulation light beam from the object, the user can determine the status of the object that according to the reflected modulation light beam and the code information within. Furthermore, the moving rate and the moving direction of the object that can estimate by the reflected modulation light beam and the corresponding code information therewithin.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a flow chart showing the steps of an optical method for detecting the object in accordance with a method disclosed herein;

FIG. 2 is a schematic representation showing a corresponding position between the light sources and the lens in accordance with a method disclosed herein;

FIG. 3 is a schematic representation showing a corresponding position between the photosensitive device and the wave filter in accordance with the method disclosed herein;

FIG. 4A is a schematic representation showing the corresponding position between the light emitting source flat array and the photosensitive device in accordance with the method disclosed herein;

FIG. 4B to FIG. 4E are schematic representation showing the corresponding position between the light sources, which with different emitting angle and the height that arranged in light emitting source flat array, and the photosensitive device in accordance with the method disclosed herein;

FIG. 5A is a schematic representation showing a corresponding position between the light sources and the photosensitive device in accordance with the method disclosed herein;

FIG. 5B is a schematic representation showing the light emitting source flat array, lens, photosensitive device, and the wave filter that located on the top flat plate and the bottom flat plate;

FIG. 6A is a schematic representation showing the size object and the object is existence or absence that is determined by the optical detecting method in according with the method disclosed herein;

FIG. 6B is a schematic representation showing the distance between the objects is determined by using the optical detecting method in accordance with the method disclosed herein;

FIG. 6C is a schematic representation showing the height of the object is determined by using optical detecting method in accordance with the method disclosed herein;

FIG. 6D is a schematic representation showing the moving direction is determined by using optical detecting method in accordance with the method disclosed herein; and

FIG. 6E is a schematic representation showing the moving rate of the object is determined by using the optical detecting method in accordance with the method disclosed herein.

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

According to the drawbacks of conventional detecting device, the present invention provides an optical method for detecting an object by utilizing the refraction and reflection in conjunction with the coded signals to emit the modulation light beam to the object from the light sources within the light emitting source flat array. Thus, the user can determine the object size; the position, the distance, the moving direction, or the moving rate that according to the reflected modulation light beam and the code information therewithin that is received by the photosensitive device.

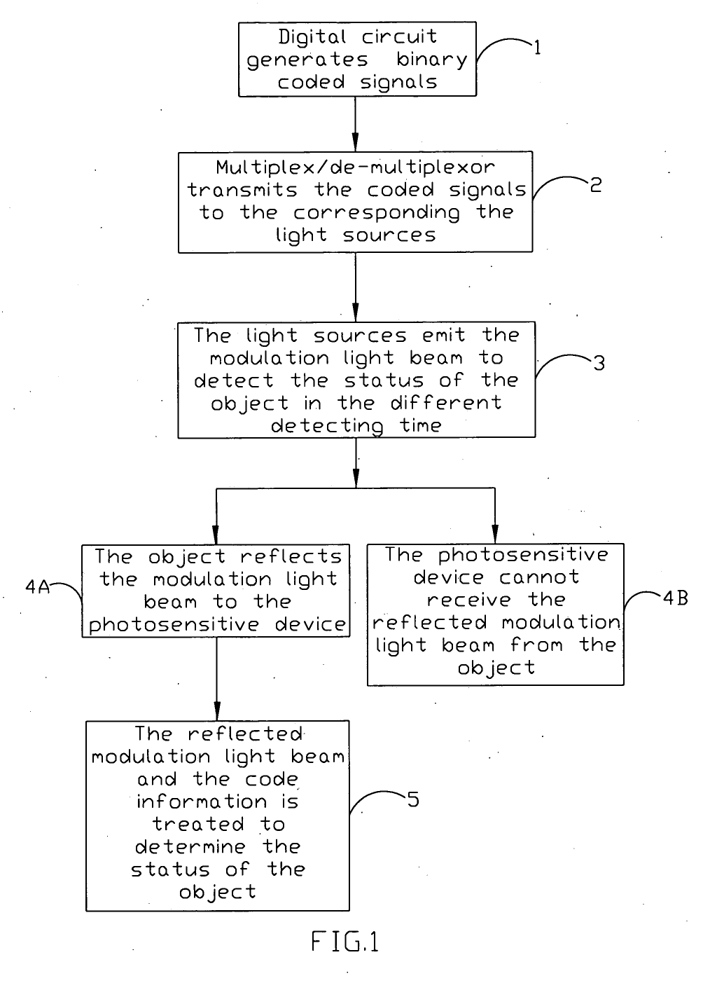

Referring to FIG. 1 showing the flow chart for the optical method for detecting an object. According to the preferred embodiment, the digital circuit generates the binary coded signals, wherein the each of coded signals is modulated to the corresponding the each of the position of the emitting sources within emitting source flat array (step 1), wherein the emitting sources can be a light sources with any wavelength. Then, the multiplex/de-multiplexor transmitted the coded signals to a corresponding the light sources (step 2). Next, the light sources emitted the modulation light beam to detect an object to obtain the status of the object such as object size, the height, the position, or the moving status of the object in the different detecting time (step 3). Step 4A represents the object that reflected the modulation light beam to the photosensitive device when the modulation light beam detect the object.

On the other hand, when the modulation light beam did not detect any object is existence in the detecting range, such that the modulation light beam will appear the dispersion, that is to say, the photosensitive device cannot receive any reflected modulation light beam from the object (step 4B). Then, the photosensitive device received the reflected modulation light beam from the step 4A, the reflected modulation light beam and the corresponding code information can be treated by the treatment device to generate the signals so as to let the user can determine the status of object such as object size, the position, the height, the distance, or the moving status of the object (step 5).

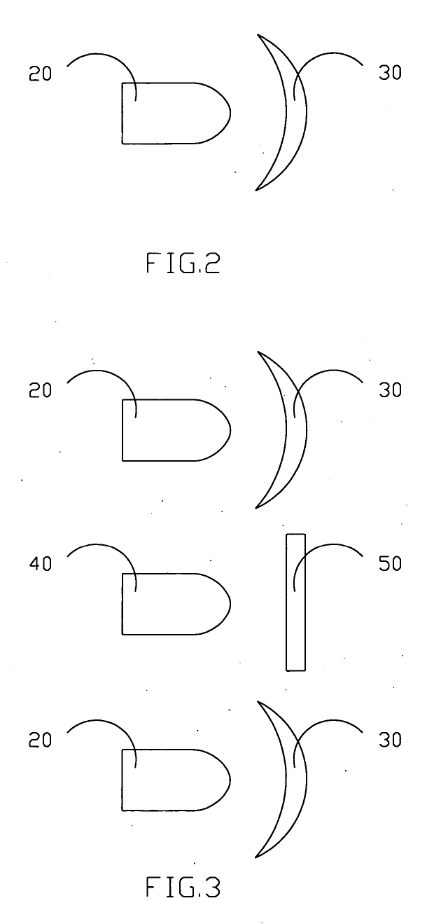

Referring to FIG. 2 showing the representation of the relative position between the light sources and the lens. In the preferred embodiment, light sources 20 emit the light beam to detect the object, wherein light sources 20 can be a light sources with any wavelength (frequency). In order to enhance the directional of the light beam and the resolution of detecting, the lens 30 is located in front of the light sources 20 to focus the light beam that is emitted from the light sources 20 to obtain the higher resolution and higher directional of the light beam to detect object accurately. Furthermore, the number of light sources and the lens is changed with the illumination, wherein the illumination denotes the light sources intensity density per unit surface on the one direction.

Due to the surface of the object could be a rough surface, thus, the reflected modulated light beam from the rough surface of the subject could exhibit the scattering to the photosensitive device 40 to decrease the detecting accurately. Thus, the illumination of the light source should be adjusted to increase the sensitivity. Therefore, each of the light sources within the light emitting source flat array have different illumination. When the light source emitted the light beam to the ground, the illumination of the reflected modulated light beam is so weak to cause the photosensitive device cannot detect the reflected light beam. Herein, the weak illumination of the reflected modulated light beam can be defined as the critical illumination. When the illumination of the reflected light beam is greater than the critical illumination, the photosensitive device 40 could determine the reflected modulated light beam is reflected by the object.

Moreover, the illumination of the light source proportion to the intensity of the voltage. Thus, the illumination of the light source can be adjusted to detect the object is absence or existence, or determine the reflected modulated light beam is reflected from the ground or from the object.

Referring to FIG. 3 showing the representation of a corresponding position between the photosensitive device and the wave filter. In the preferred embodiment, the photosensitive device 40 used to receive the reflected modulation light beam, wherein the photosensitive device 40 can be a photosensitive device with any wavelength. In order to enhance the S/N ratio of the photosensitive device 40, the wave filter 50 is located in front of the photosensitive device 40 to block the unnecessary wavelength that is emitted from the other light sources to increase the detecting accurately, wherein the wave filter 50 with variety wavelength as same as the wavelength of the lens 30, photosensitive device 40, and the light sources 20.

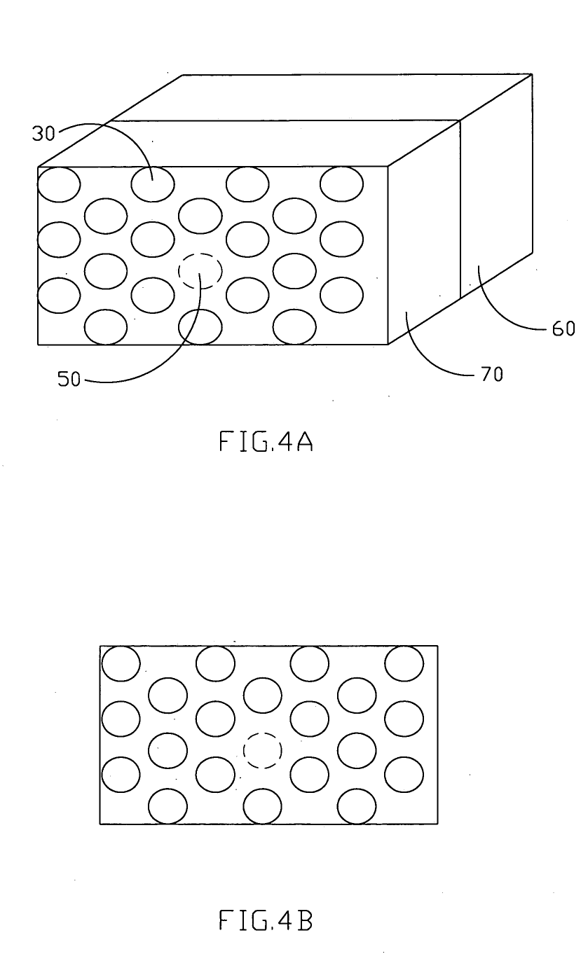

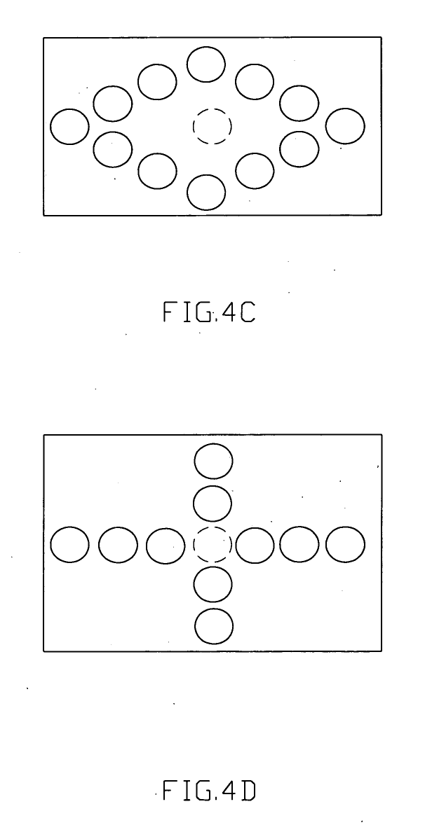

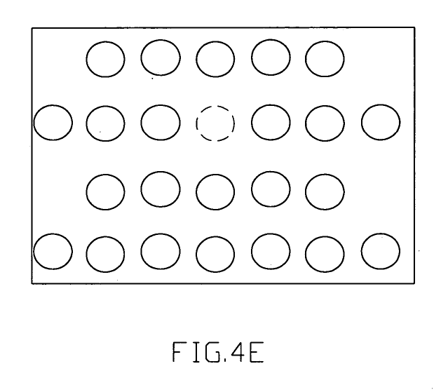

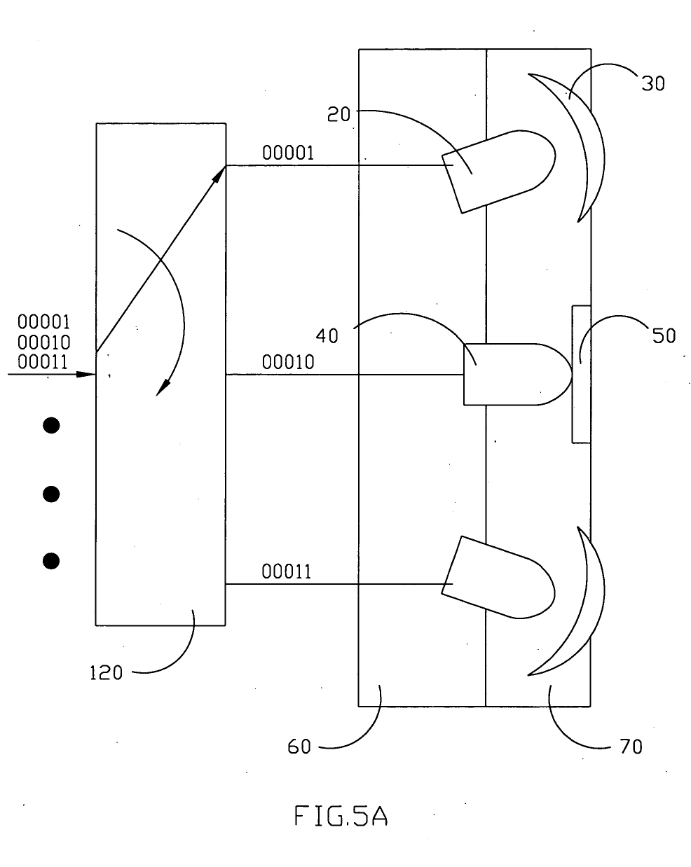

Referring to FIG. 4A represents the plurality of light sources 20 and the photosensitive device 40 arrange to a light emitting source flat array and with the different height and the different emitting angle. The circle denotes the light sources 20; and the dotted line of the circle denotes the photosensitive device 40. In general, at least a photosensitive device 40 is located within the light emitting source flat array to receive the reflected modulation light beam in different reflected time. Referring to the FIG. 4B to FIG. 4E that represent the position of the light sources with different arrangement in the light emitting source flat array and the photosensitive device. The light sources arranged with different angle and the height within the light emitting source flat array source, so as to the status of the object such as the size, the height, the distance, and the moving direction and the moving rate of the object can be measured.

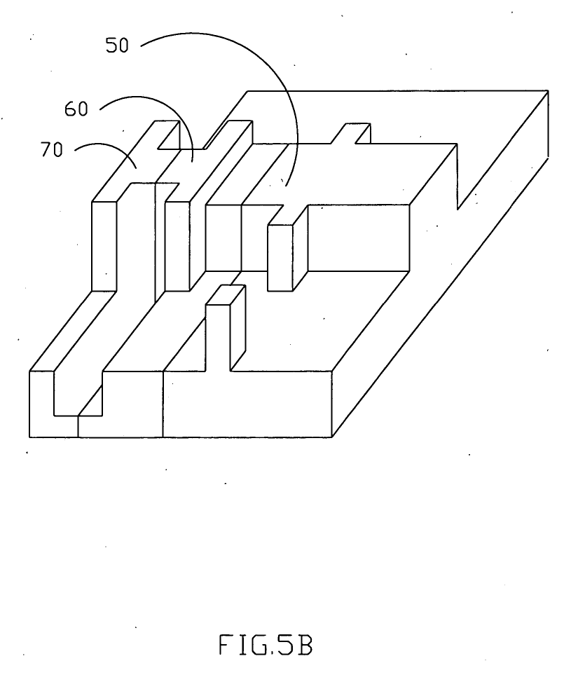

Referring to FIG. 5A, binary coded signals are generated from the digital circuit in the present invention. Furthermore, the most generation method is to utilize the chips such as 8051 microcontroller to generate the required binary codes in designed time. If the higher detecting speed is required, the FPGA (Field Programmable Gate Arrays) or DSP (Digital Signal Processing) can generate the higher speed binary coded signals to detect the object with higher speed. The plurality of binary coded signals, for example, 00001, 00010, 00011, which are generated by the digital circuit. Then, the contact signal line (not shown) of the light sources 20 is electrically coupled with the multiplex/de-multiplexor 120, and the binary coded signals are generated from the multiplex/de-multiplexor 120 in the designed time. The plurality of binary coded signasl are transmitted to the light sources 20 with different emitting angle in the each different position within the light emitting source flat array. Next, the light sources emitting the light beam, which is modulated to detect the object through the lens 30, wherein the modulation light beam is corresponding to the light sources 20, and each light sources 20 is corresponding to each coded signals.

When the modulation light beam is emitted from the light sources 20 to detect the object, the object will reflect the reflected modulation light beam to the photosensitive device 40 to receive the reflected modulation light beam. In the preferred embodiment, the light sources 20, lens 30, photosensitive device 40, and the wave filter 50 are fixed by the top flat plate 60, and the bottom flat plate 70 used to fix the photosensitive device 40, lens 30, and the wave filter 50. Then, the FIG. 5 B showing the light emitting source flat array, the lens 30, the photosensitive device 40, and the wave filter 50 are located between the top flat plate 60 and bottom flat plate 70.

On the other hand, in the preferred embodiment of the present invention, the modulation light beam is emitted from the light sources 20, thus, the object will reflect the modulation light beam to the photosensitive device 40, and further the photosensitive device 40 will transmit the reflected modulation light beam to the treatment device such as FPGA or DSP to convert the digital signals into the analog signals or convert the analog signals into the digital signals. Moreover, the treatment device is communicated the result to the display device to display the result, herein the result can be a signal that displayed by oscillogram in an oscilloscope. Therefore, the object size, the position, the height, or the moving direction and moving rate can be estimated.

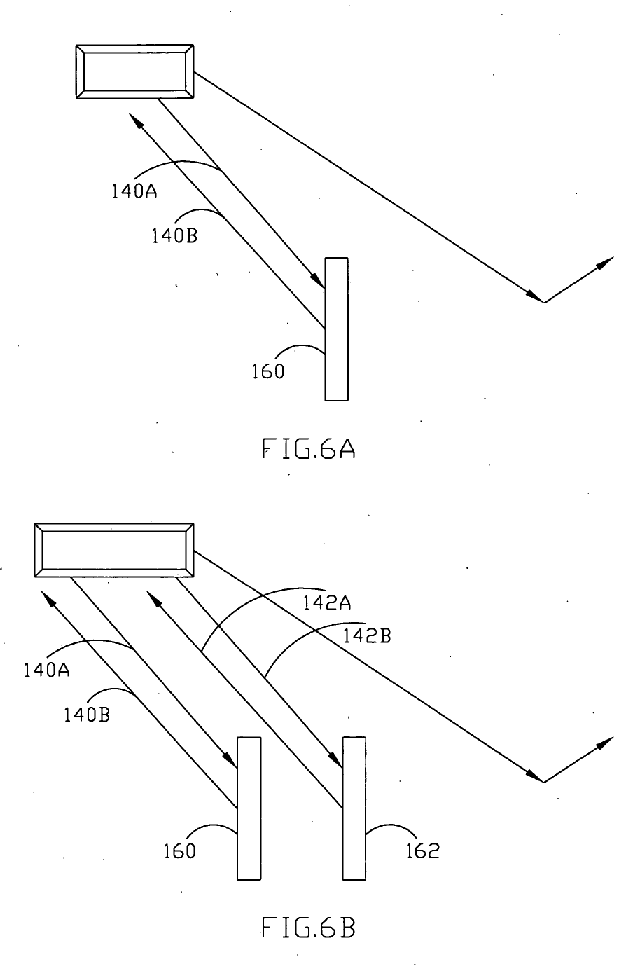

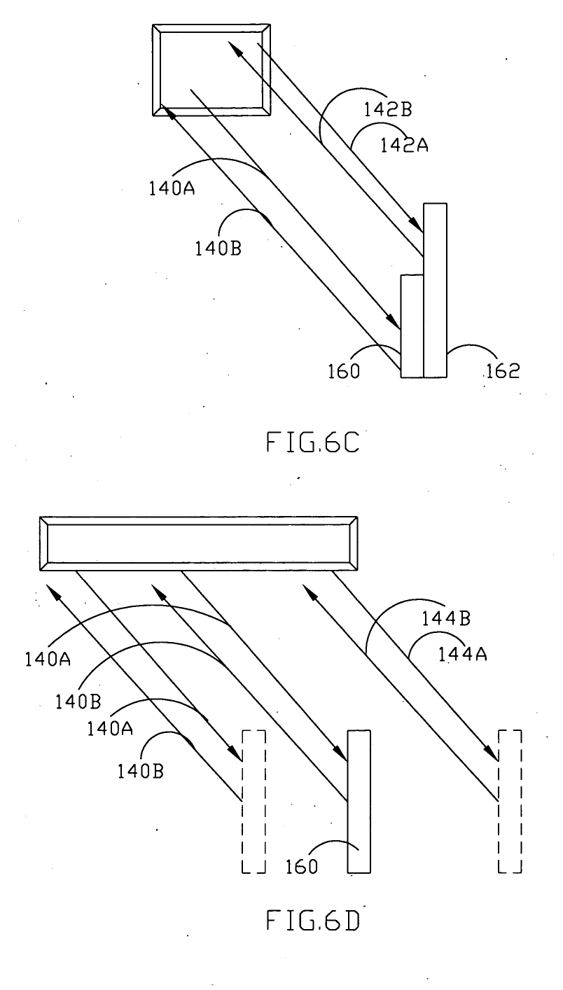

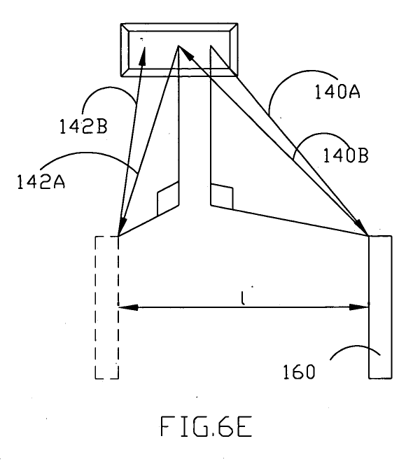

FIG. 6A represents the optical method that utilized the modulation light beam to detect the object size. The modulation light beam 140A is emitted from the light sources 20 to detect the object 160, such that the object 160 will reflect the reflected modulation light beam 140B, and the reflected modulation light beam will de-modulation to obtain the code information that corresponding to the modulation light beam to the photosensitive device to determine the object is existence or absence. If the photosensitive device did not receive the reflected modulation light beam, so that the object 140 is absence in the detecting range.

Referring to FIG. 6B represents the optical method to detect the distance of the object. When the optical method is used to detect the distance between the each of the two objects and the light sources, the light sources emitted the two modulation light beams 140A/142A respectively and the corresponding code information denote 00001/00010 respectively to detect the object 160/162, wherein the first modulation light beam 140A and the corresponding code information denotes 00001 represents the light sources which is located on the lower position within the light emitting source flat array, and the second modulation light beam 142A and the corresponding code information denotes 00010 represents the light sources that located at the higher position within the light emitting source flat array.

When the first modulation light beam 140A and the second modulation light beam 142 detect the object 160/162, the object 160/162 will reflect the first or second modulation light beam 140B/142B to the photosensitive device, so as to the photosensitive device receive the first modulation light beam 140B in the first time or the second modulation light beam 142B in the second time. When the photosensitive device received the reflected modulation light beam and the corresponding code information in the first reflected time, the user can determine the light beam that is emitted from the higher or lower position of the light sources within the light emitting source flat array.

When the photosensitive device received the second modulation light beam 142B and the corresponding code information denotes 00010, the user also can determine the position of the light sources is higher position within the light emitting source flat array. Thus, the distance between the object and the light sources can be determined by the reflected modulation light beam and the corresponding code information. If the photosensitive device received the first reflected modulation light beam 140B and the corresponding code information denotes 00001, the distance of the object is near the light emitting source flat array; nevertheless, the photosensitive device received the second reflected modulation light beam 142B and the corresponding code information denotes 00010, so as to the user can determine the distance of the object is far away from the light emitting source flat array

Referring to FIG. 6C represents the optical method for detecting the height of the object. The two objects 160/162 have the different height in the detecting range. The second modulation light beam 142A is emitted from the light sources with higher height within light emitting source flat array, and the corresponding code information denotes 00010; the first modulation light beam 140A is emitted from the light sources that is located at the lower position within the light emitting source flat array, and the corresponding code information denotes 00001.

When the modulation light beam is emitted from the light sources to detect the object, the photosensitive device received the reflected second reflected modulation light beam 142B and the corresponding code information denotes 00010, the user can determine the object with higher height. Else, the photosensitive device received the first reflected modulation light beam 140B, and the corresponding code information denotes 00001, thus, the user can determine the object with short height.

Furthermore, referring to FIG. 6D, the light sources located at the middle of the light emitting source flat array that denotes the first modulation light beam 140A, and the corresponding code information denotes 00001; the light sources located at the left of the light emitting source flat array that denotes the second modulation light beam 142A; and the light sources located at the right of the light emitting source flat array 144A and the corresponding code information denotes 00011. The detecting method is that the modulation light beam is emitted from the light sources to detect the motion status of the object 160, the user can firstly determine the object is existence or absence by the reflected modulation light beam from the object, and the motion status of the object is obtained by the photosensitive device received the first reflected modulation light beam and the corresponding code information in a designed time after the reflected modulation light beam is treated by de-modulation. Thus, the photosensitive device received the first reflected modulation light beam 142B, and the corresponding code information denotes 00010, so as to the user can determine the object 160 moving toward the left direction; else, the photosensitive device received the third reflected modulation light beam 144B and the corresponding code information denotes 00011, the user can determine the object 160 moving toward the right direction.

Moreover, the following description represents the optical method for detecting the moving rate of the object. As shown in FIG. 6E, the first modulation light beam 140A and the corresponding code information denotes 00001 is emitted from the light sources and located at the right side of the light emitting source flat array, and the second modulation light beam 142A, and the corresponding code information denotes 00001 is located at the left side of the light emitting source flat array. When the photosensitive device received the first reflected modulation light beam 140B in the first reflected time, the user can determine the object is existence or absence. Then, when the object is moving, the photosensitive device can receive the second reflected modulation light beam 142B, and the corresponding code information denotes 00010, such that the user not only obtain the moving direction of the object, but also the moving rate of the object, wherein the moving rate can calculate by the Newton first moving theorem, the moving distance L divide the difference between the first reflected time and the second reflected time to obtain the moving rate of the object, the calculation equation as following:
V=L(t₁-t₂),
wherein the V denotes the moving rate of the object, t₁ denotes the first reflected time, and the t₂ denotes the second reflected time.

Although specific embodiments have been illustrated and described, it will be obvious to those skilled in the art that various modifications may be made without departing from what is intended to be limited solely by the appended claims.

1. An optical method for detecting an object, said optical method comprising:
generating a plurality of coded signals;
communicating said plurality of coded signals to a corresponding plurality of light sources;
modulating said plurality of light sources according to said plurality of coded signals;
emitting a modulated light beam to said object from said plurality of light sources;
receiving a reflected modulated light beam reflected from said object;
de-modulating said reflected modulated light beam to obtain a code information therewithin; and
determining a status of said object according to said de-modulated code information of said reflected modulated light beam.

2. The optical method according to claim 1, wherein said plurality of coded signals are coded in binary coding.

3. The optical method according to claim 1, wherein said plurality of light sources have different emitting angle within a light emitting source flat array.

4. The optical method according to claim 1, wherein said plurality of light sources have different illumination within a light emitting source flat array.

5. The optical method according to claim 3, further comprising a plurality of lens located in front of said plurality of light sources to focus said modulated light beam that is emitted from said plurality of light sources.

6. The optical method according to claim 1, wherein said receiving said reflected modulated light beam can be a photosensitive device, wherein wavelength of said photosensitive device is same as said plurality of said light sources.

7. The optical method according to claim 5, further comprising a wave filter located in front of said photosensitive device, wherein wavelength of said wave filter is same as said photosensitive device.

8. An optical method for detecting an object, said optical method comprising:
providing a plurality of coded signals, wherein said plurality of coded signals are coded in binary coding;
communicating said plurality of coded signals to a corresponding plurality of light sources;
emitting a plurality of modulated light beam to said object;
receiving a plurality of reflected modulation light beam from said object;
de-modulating said plurality of reflected modulation light beam to obtain a code information therewithin; and
determining the status of said object according to said de-modulated code information.

9. The optical method according to claim 8, wherein said plurality of light sources have different emitting angle within a light emitting source flat array.

10. The optical method according to claim 8, wherein said plurality of light sources have different illumination within a light emitting source flat array.

11. The optical method according to claim 8, wherein said object which reflected a first reflected modulated light beam in a first reflected time that is near said light emitting source flat array.

12. The optical method according to claim 8, wherein said object reflecting a second reflected modulated light beam in a second reflected time is far away said light emitting source flat array, wherein said second reflected time is longer than said first reflected time.

13. The optical method according to claim 8, wherein said object with short height that reflected a first reflected modulation light beam in a first reflected time.

14. The optical method according to claim 8, wherein said object reflecting a second reflected modulation light beam in a second reflected time that is object with higher height.

15. An optical detecting object apparatus, said apparatus comprising:
a digital circuit, said digital circuit generating a plurality of coded signals;
a multiplex, said multiplex communicating said plurality of coded signals to a corresponding plurality of light sources;
said plurality of light sources emitting the modulated light beam to detect an object;
a plurality of lens, said plurality of lens located in front of said plurality of said light sources and focused said modulation light beam;
at least a photosensitive device, at least said photosensitive device located within said plurality of light sources to receive a reflected modulated light beam;
at least a wave filter, at least said wave filter located in front of at least said photosensitive device; and
a treatment device, said treatment device used to treat said plurality of said reflected modulated light beam and said corresponding code information within to determine a status of said object.

16. The apparatus according to claim 15, wherein said plurality of coded signal is coded in binary code.

17. The apparatus according to claim 15, wherein said plurality of light sources with different emitting angle within a light emitting source flat array.

18. The apparatus according to claim 15, wherein said plurality of light sources with different illumination within a light emitting sources flat array.

19. The apparatus according to claim 15, wherein the wavelength of said plurality of lens is same as said plurality of light sources.

20. The apparatus according to claim 15, wherein the wavelength of at least said photosensitive device is same as said plurality of light sources.

21. The apparatus according to claim 15, wherein the wavelength of said wave filter is same as at least said photosensitive device.
